(19) United States
(12) Patent Application Publication
(10) Pub. No.: US 2007/0154359 A1
(43) Pub. Date: Jul. 5, 2007

(54) Conditioning a de-sulfurization system

(76) Inventors: Parshant Dhand, Troy, NY (US); Troy H. Scriven, Waterford, NY (US); Richard J. Graham, Scotia, NY (US); David B. Parry, Clifton Park, NY (US); Alan S. Feitelberg, Niskayuna, NY (US)

Correspondence Address: TROP PRUNER & HU, PC, 1616 S. VOSS ROAD, SUITE 750, HOUSTON, TX, 77057-2631, US

(21) Appl. No.: 11/321,907

(22) Filed: Dec. 29, 2005

(51) Int. Cl. F01N 3/20; H01M 8/06; H01M 8/04

(52) U.S. Cl. 422/105; 429/19; 429/25

(57) ABSTRACT

A fuel cell system includes a de-sulfurization tank, a reformer, a pressure monitoring device and a fuel cell stack. The de-sulfurization tank includes an agent that is adapted to remove sulfur compounds and is capable of undergoing a conditioning cycle. The tank includes an inlet to receive a first hydrocarbon flow and an outlet to provide a second hydrocarbon flow. The reformer is adapted to convert the second hydrocarbon flow into a reformate flow, which is received by the fuel cell stack. The pressure monitoring device monitors a pressure of the second hydrocarbon flow, a circuit of the fuel cell system is coupled to the pressure monitoring device to determine whether the conditioning of the tank is complete based on the pressure.

### BACKGROUND

The invention generally relates to a de-sulfurization system and more particularly relates to an in situ method of conditioning a fixed bed de-sulfurizer.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange member (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, such as a cooling subsystem, a cell voltage monitoring subsystem, a control subsystem, a power conditioning subsystem, etc. The particular design of each of these subsystems is a function of the application that the fuel cell system serves.

### SUMMARY

In an embodiment of the invention, a technique includes providing an agent to remove sulfur compounds from a gaseous hydrocarbon and conditioning the agent. The conditioning includes communicating a first hydrocarbon flow to the agent and monitoring a second hydrocarbon flow that is produced by the communication. Based on a characteristic of the second hydrocarbon flow, a determination is made whether the conditioning is complete.

In another embodiment of the invention, a fuel cell system includes a de-sulfurization tank, a reformer, a pressure monitoring device and a fuel cell stack. The de-sulfurization tank includes an agent that is adapted to remove sulfur compounds and is capable of undergoing a conditioning cycle. The tank includes an inlet to receive a first hydrocarbon flow and an outlet to provide a second hydrocarbon flow. The reformer is adapted to convert the second hydrocarbon flow into a reformate flow, which is received by the fuel cell stack. The pressure monitoring device monitors a pressure of the second hydrocarbon flow, and a circuit of the fuel cell system is coupled to the pressure monitoring device to determine whether the conditioning of the tank is complete based on the pressure.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIGS. 2 and 4 are flow diagrams depicting techniques to start up a fuel cell system according to embodiments of the invention.

FIG. 3 is an illustration of pressure and flow waveforms associated with the conditioning of a de-sulfurization tank according to an embodiment of the invention.

### DETAILED DESCRIPTION

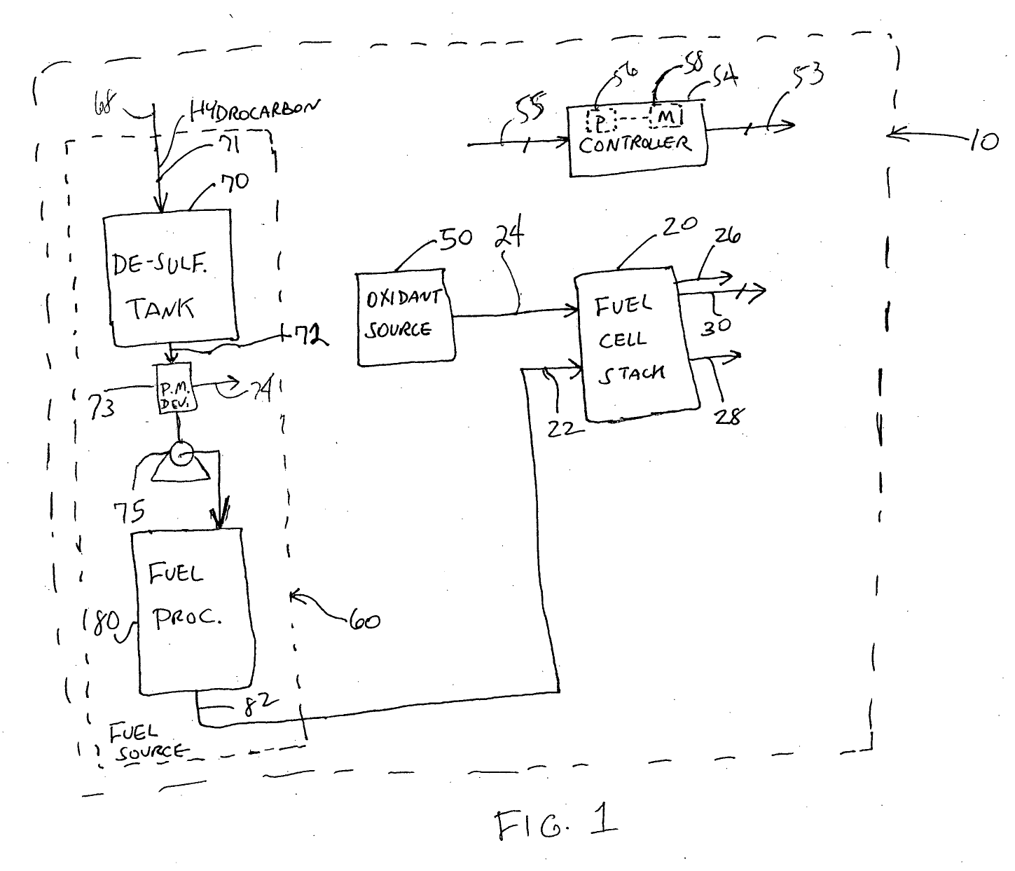

Referring to FIG. 1, a fuel cell system in accordance with an embodiment of the invention includes a fuel cell stack 20 that, in its normal course of operation, produces electrical power in response to incoming oxidant and fuel flows. The fuel flow originates with an incoming hydrocarbon flow from a hydrocarbon supply line 68. In this regard, the hydrocarbon supply line 68 provides a vapor phase hydrocarbon flow (liquefied petroleum gas (LPG) or natural gas, as non-limiting examples).

The incoming hydrocarbon flow may contain various sulfur compounds, such as intentionally added odorants for purposes of facilitating leak detection, as well as residual sulfur compounds that are left over from the well and processing plant. As a more specific example, the incoming hydrocarbon flow may contain mercaptans, thiophenes, H₂S and COS. These sulfur compounds have the potential of harming components of the fuel cell system 10 if not significantly removed. For example, the sulfur compounds may poison the reformer as well as poison the catalysts in the membrane electrode assemblies (MEAs) of the fuel cell stack. Therefore, the fuel cell system 10 includes a de-sulfurization tank 70 to, as its name implies, remove sulfur compounds from the incoming hydrocarbon flow. The de-sulfurization tank 70 may include multiple fixed bed agents, one of which may contain an adsorbent agent bed, such as a zeolite-based agent, which must undergo a “conditioning cycle” (described further below) before the hydrocarbon flow that exits an outlet 72 of the tank 70 matches the incoming hydrocarbon flow to the tank 70. Thus, while being conditioned, the de-sulfurization tank 70 may not be able to supply an adequate hydrocarbon flow to the rest of the fuel cell system, thereby potentially causing errant operation of the fuel cell system. However, as described further below, the fuel cell system 10 includes certain features to detect the state of the de-sulfurization tank 70 for purpose of determining when conditioning of the tank 70 is complete.

The conditioning cycle is attributable to the high affinity that the zeolite-based agent has for the hydrocarbon molecules of the incoming hydrocarbon flow. Therefore, although the zeolite-based agent attracts (via absorption, chemisorption, physisorption or a combination of these mechanisms) sulfur-containing molecules from the flow, the pores of the zeolite-based agent initially attract a considerable amount of hydrocarbon molecules. Therefore, in order for the de-sulfurization tank 70 to finction as intended, the zeolite-based agent must become saturated with the hydrocarbons (i.e., conditioned) before the outgoing flow rate from the tank 70 matches its incoming flow rate.

In other embodiments of the invention, as will be appreciated by one skilled in the art, other de-sulfurization agents, other than zeolite-based agents, which have a high affinity for hydrocarbon molecules and need to undergo a conditioning cycle may be used in place of the zeolite-based agent as described in this application.

Thus, when the de-sulfurization tank 70 is new or has not been used for a significant period of time, a relatively large pressure drop occurs across the tank 70 between its inlet and outlet. In this state of the de-sulfurization tank 70, the flow from the tank 70 is unpredictable and is greatly reduced from the flow that enters the tank 70. This may cause errant operation of the downstream components that receive the outgoing flow from the de-sulfurization tank 70 if the existence of the conditioning cycle is unrecognized. At the conclusion of the conditioning cycle, the inlet and outlet pressures of the tank 70 are virtually the same, as well as its inlet and outlet flow rates.

Therefore, in accordance with embodiments of the invention described herein, the fuel cell system 10 has features (further described below) to detect the end of a conditioning cycle so that normal operations of the fuel cell system 10 may commence. It is noted that in the context of this application, the “conditioning of the tank 70” and the “conditioning of the zeolite-based agent” are used interchangeably

During its normal power producing operation, the fuel cell stack 20 receives its incoming fuel flow (provided by a fuel source 60) and oxidant flow (provided by an oxidant source 50, such as an air blower) at an anode inlet 22 and a cathode inlet 24, respectively. Inside the fuel cell stack 20, the fuel flow is routed from the anode inlet 22, through the anode flow channels of the fuel cell stack 20 and appears as anode exhaust at an anode outlet 28. It is noted that the anode exhaust may be routed back through the fuel cell stack 20 in accordance with some embodiments of the invention. In other embodiments of the invention, however, the anode exhaust may not be rerouted through the fuel cell stack 20. Furthermore, in accordance with some embodiments of the invention, the fuel cell stack 20 may be “dead-headed,” which means that the anode chamber of the fuel cell stack 20 is closed off so that no anode exhaust leaves the fuel cell stack 20. Thus, many variations are possible and are within the scope of the appended claims.

The oxidant flow is communicated from the oxidant inlet 24, through the cathode flow channels of the fuel cell stack 20 and appears as cathode exhaust at an oxidant outlet 26 of the fuel cell stack 20. It is noted that, depending on the particular embodiment of the invention, the cathode exhaust may be routed to a flare or oxidizer; or, alternatively, the cathode exhaust may be rerouted back through the fuel cell stack 20. In other embodiments of the invention, the cathode exhaust may be routed to a fuel processor 80 of the fuel cell system 10 to at least provide some of the air for the fuel processor 80.

Stack output terminals 30 of the fuel cell stack 20 provide a DC output voltage, a voltage that may be regulated to a particular DC level or to a particular AC voltage, depending on the type of load to the system 10.

The de-sulfurization tank 70 is part of the fuel source 60 that supplies the fuel to the anode inlet 22 of the fuel cell stack 20. The fuel source 60 also includes a fuel processor 80 that receives the outgoing flow from the de-sulfurization tank 70 and provides a reformate flow (i.e., the fuel flow to the stack 20) at an outlet 82 of the fuel processor 80. As an example, the fuel processor 80 may mix the incoming flow with steam for purposes of aiding an autothermal reformer or a steam reformer of the fuel processor 80. Besides the autothermal reformer or the steam reformer, the fuel processor 80 may include, as examples, low temperature shift (LTS) and high temperature shift (HTS) reactors as well as a preferential oxidation (PROX) reactor, in accordance with some embodiments of the invention.

For purposes of inducing a continuous flow through the de-sulfurization tank 70 during the conditioning cycle, the fuel source 60 includes a blower 75 that has its suction inlet connected to an outlet 72 of the de-sulfurization tank 70. The outlet of the blower 75 is connected to the inlet of the fuel processor 80. Thus, the blower 75 is controlled to establish a suction on the outlet 72 of the de-sulfurization tank 70 during the conditioning cycle. In some embodiments of the invention, the blower 75 may be a variable speed blower whose speed is varied during the normal course of operation of the fuel cell system 10; and the speed of the blower 75 may be set at its maximum for the duration of the conditioning cycle.

Among its other features, the fuel cell system 10 may include a controller 54 that regulates various operations of the fuel cell system 10. In this regard, the controller 54 may include a processor 56 (one or more microprocessors or microcontrollers, for example) that is coupled to a memory 58. The memory may store, for example, instructions that when executed by the processor 56 cause the processor 56 to perform various techniques, including the techniques that are disclosed herein. The controller 54 includes input terminals 55 that receive various status signals, indications of commands, etc. from the components of the fuel cell system 10. In response to the inputs received at the input terminals 55, the controller 54 produces various control signals on its output terminals 53 for purposes of controlling motors, controlling valves, communicating with other entities, etc.

For purposes of starting up the fuel cell system 10, the controller 54 determines when the conditioning of the de-sulfurization tank 70 is complete. One way to accomplish this is to measure a certain length of time, and when the time expires, it is assumed that the de-sulfurization tank 70 is conditioned. However, this technique may not be reliable.

As described herein, more reliable techniques to determine whether the conditioning cycle is complete involve monitoring a characteristic of the outgoing flow from the de-sulfurization tank 70.

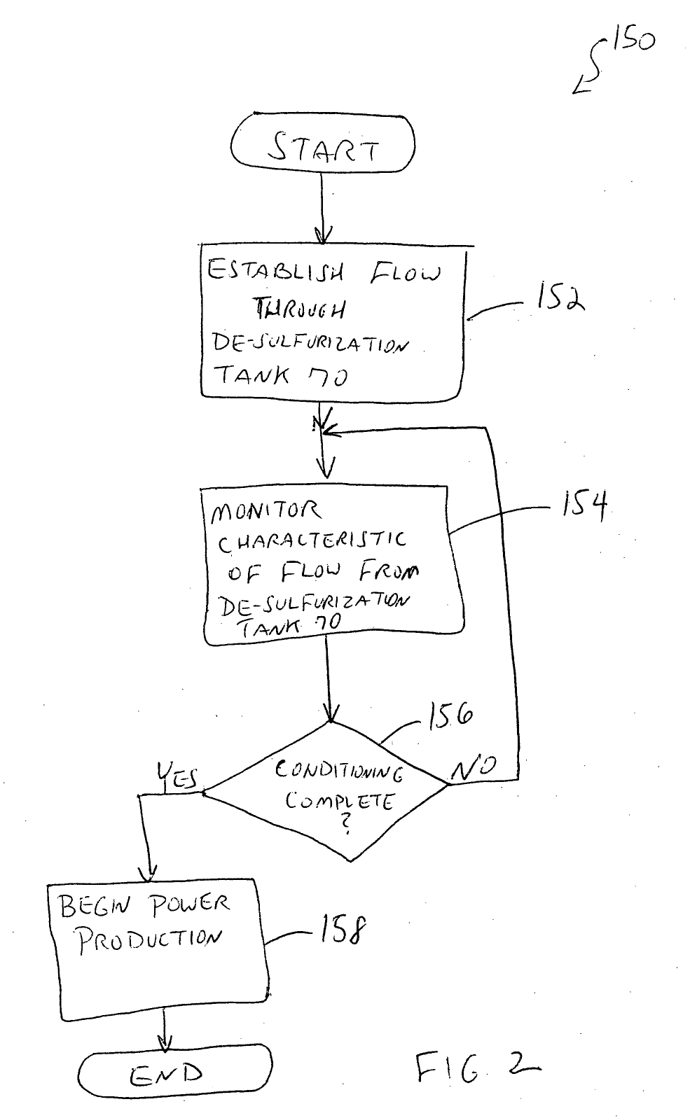

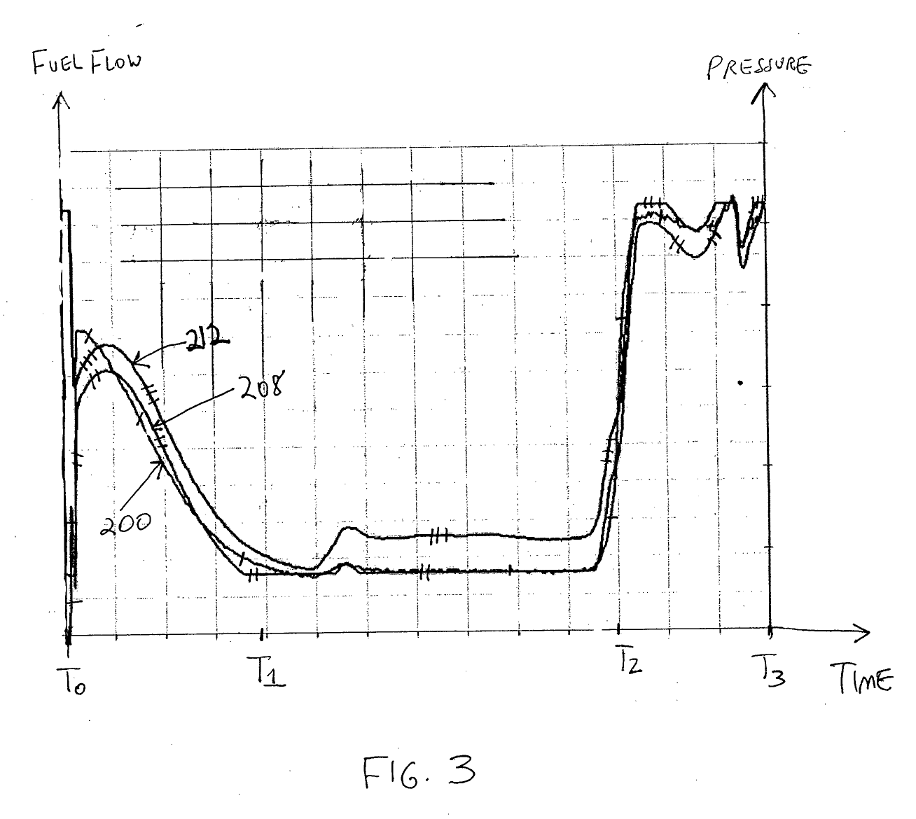

For example, the outgoing flow rate from the de-sulfurization tank 70 may be monitored to detect the end of the conditioning cycle in accordance with some embodiments of the invention. Referring to FIG. 3 in conjunction with FIG. 2, the tank 70 may have an outgoing flow 200 during the conditioning cycle. More particularly, at time T₀, the conditioning of the de-sulfurization tank 70 begins as the valve(s) to the tank 70 are opened to allow the hydrocarbon flow to be received into the tank 70. This initial flow into the de-sulfurization tank 70 causes the flow 200 to initially increase at time T₀. However, from time T₀ to time T₁ the flow 200 from the de-sulfurization tank 70 decreases, as conditioning of the tank 70 begins. The conditioning continues until time T₂, a time at which the flow 200 from the tank 70 rises upwardly and thereafter continues at the increased level as conditioning is complete. Thus, as can be seen from FIG. 3, the flow from the outlet 72 of the de-sulfurization tank 70 may be monitored, so that the event of the flow surpassing a predetermined threshold may be used to detect completion of the conditioning.

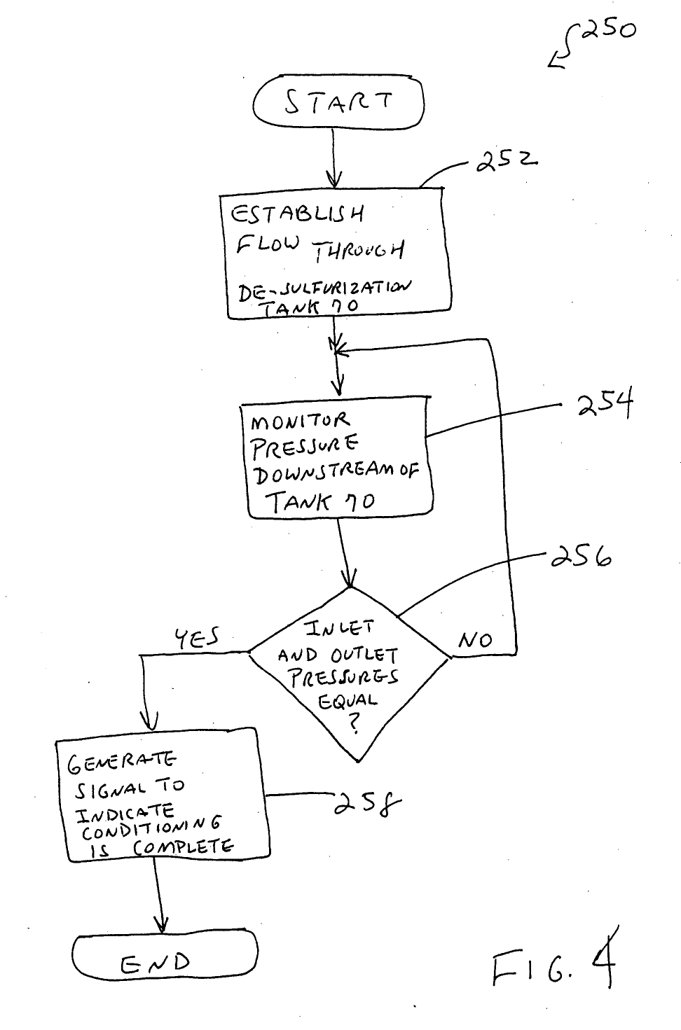

Alternatively, a pressure associated with the flow from de-sulfurization tank 70 may be monitored for purposes of detecting the completion of the conditioning cycle. For example, FIG. 3 depicts exemplary inlet 212 and outlet 208 pressures of the tank 70, which are present during the conditioning of the tank 70. There is an initial surge in the inlet 212 and outlet 208 pressures when the hydrocarbon flow into the de-sulfirization tank 70 begins. After time T₀, the inlet 212 and outlet 208 pressures decrease; and at time T₃, the inlet 212 and outlet 208 pressures rise. As depicted in FIG. 4, the outlet pressure 208 remains below the inlet pressure 212 during the conditioning from time T₀ to time T₃; and near time T₃, the inlet 212 and outlet 208 pressures equalized at the completion of the conditioning. Therefore, as can be seen from FIG. 3, the inlet 212 and outlet 208 flows may be monitored, so that the event of the inlet and outlet flows 212 equalizing may be used to detect completion of the conditioning. It is noted that the equalization may be detected in some embodiments of the invention by comparing the outlet pressure 208 to a predetermined pressure threshold, as the inlet pressure 212 may be a known pressure established by supply line (an LPG supply line, for example) that feeds the de-sulfurization tank 70.

Referring back to FIG. 1, to detect the end of the conditioning cycle, the fuel source 60 includes a pressure monitoring device 73 that is connected to the outlet 72 of the de-sulfurization tank 70 to monitor the pressure of the outgoing flow from the tank 70. More specifically, the pressure monitoring device 73 provides a signal (at its output terminal 74) that is indicative of the pressure in the outgoing flow. As depicted in FIG. 1, the pressure monitoring device 73 may be connected between the tank outlet 72 and the inlet of the blower 75, in some embodiments of the invention.

In accordance with some embodiments of the invention, the pressure monitoring device 73 may be a pressure switch that provides a given signal at the output terminal 74 when the crossing of a predetermined pressure threshold is detected . Alternatively, the pressure monitoring device 73 may be a pressure sensor that provides an analog or digital signal at the output terminal 74, which is indicative of the measured pressure. As yet another example, the pressure monitoring device 73 may be a flow meter in other embodiments of the invention. It is noted that due to its relative cost and ease of use (little or no calibration, for example), the pressure switch may be the most desirable choice, although many variations of the pressure monitoring device are possible and within the scope of the appended claims.

Referring to FIG. 2 in conjunction with FIG. 1, to summarize, in accordance with some embodiments of the invention, the controller 54 may perform a technique 150 to start up the fuel cell system 10. Pursuant to the technique 150, the controller 54 first establishes (block 152) a flow through the de-sulfurization tank 70. For example, the controller 54 may open one or more valves to establish flow into and out of the de-sulfurization tank 70, as well as turn on the blower 75 to establish suction at the outlet 72 of the tank 70 to induce a continuous flow through the tank 70. Next, the controller 54 monitors (block 154) a characteristic of the flow from the de-sulfurization tank 70 and based on this characteristic, the controller 54 determines (diamond 156) whether the conditioning of the tank 70 is complete. If so, then the controller 54 generates a signal (a physical analog or digital signal, or a software signal, as examples) to begin the normal state of operation in which the fuel cell system 10 produces power. Thus, during the conditioning cycle, the components downstream of the de-sulfurization tank 70 may merely serve as conduits to vent the flow from the tank 70. However, after the end of the conditioning cycle is detected, normal operations begin in which the downstream components use the flow from the tank 70 to produce electrical power. It is noted that during the conditioning cycle, the flow from the de-sulfurization tank 70 may be diluted using downstream components of the fuel cell system 10 for purposes of venting the flow to the atmosphere. For example, during the conditioning of the de-sulfurization tank 70, an air blower inside the fuel processor 80, as well as an air blower for the fuel cell stack 20 may be operated to dilute the flow from the tank 70.

FIG. 4 depicts a general technique 250 when the pressure is monitored to detect the end of the conditioning cycle. Pursuant to the technique 250, the controller 54 establishes (block 252) a flow through the de-sulfurization tank 70. Next, the controller 54 monitors (block 254) the pressure downstream of the de-sulfurization tank 70. If the controller 54 determines (diamond 256) that the inlet and outlet pressures of the tank 70 are approximately equal, then the controller 54 generates (block 258) a signal to indicate that conditioning of the de-sulfurization tank 70 is complete.

Many different embodiments of the invention, other than embodiments specifically described herein, are contemplated and are within the scope of the appended claims. For example, the fuel cell system 10 may use one of a variety of different fuel cell technologies. As non-limiting examples, the fuel cell stack 20 may include PEM-based fuel cells, alkaline-based fuel cells, phosphoric acid-based fuel cells, molten carbonate fuel cells or solid fuel oxide fuel cells (SOFCs). Furthermore, although a fuel cell system is described herein, the de-sulfurization bed conditioning and conditioning detection that are described herein may be used in connection with systems other than fuel cell systems, which use a hydrocarbon that passes though a sulfur-removing agent. Thus, many variations are possible and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
providing an agent to remove sulfur compounds from a gaseous hydrocarbon;
conditioning the agent, the conditioning comprising communicating a first hydrocarbon flow to the agent and monitoring a second hydrocarbon flow produced by the communication; and
based on a characteristic of the second hydrocarbon flow, determining whether the conditioning is complete.

2. The method of claim 1, wherein the characteristic comprises a pressure of the second hydrocarbon flow.

3. The method of claim 1, wherein the characteristic comprises a flow rate of the second hydrocarbon flow.

4. The method of claim 1, wherein the act of providing the agent comprises providing a zeolite-based agent.

5. The method of claim 1, wherein the act of determining comprises:
determining that the conditioning is complete in response to a pressure of the second hydrocarbon flow being near a pressure of the first hydrocarbon flow.

6. The method of claim 1, further comprising:
generating a signal indicative that the conditioning is complete in response to the characteristic.

7. The method of claim 6, wherein the act of generating the signal comprises:
providing at least one of a pressure switch, a pressure sensor and a flow meter to provide an indication of the characteristic of the second hydrocarbon flow.

8. The method of claim 1, further comprising:
beginning operation of a system that uses the second hydrocarbon flow in response to the determination that the conditioning is complete.

9. The method of claim 1, further comprising:
beginning operation of a fuel cell system that uses the second hydrocarbon flow for fuel based on the determination that the conditioning is complete.

10. The method of claim 9, further comprising:
beginning power production from a fuel cell stack of the system in response to the determination.

11. The method of claim 9, wherein the fuel cell system comprises at least one of the following:
a PEM fuel cell, a solid oxide fuel cell, a molten carbonate fuel cell and a phosphoric acid fuel cell.

12. The method of claim 1, further comprising:
operating a blower downstream of the agent to aid in establishing the second flow.

13. The method of claim 12, wherein a speed of the blower varies during operation of a system that uses the second hydrocarbon flow, and the act of operating comprises:
operating the blower near a maximum speed of the blower during the conditioning of the agent.

14. The method of claim 12, further comprising:
positioning the blower downstream of a pressure monitoring device used to measure the pressure.

15. A system comprising:
a de-sulfurization tank comprising an agent to remove sulfur compounds, the tank comprising an inlet to receive a first hydrocarbon flow and an outlet to provide a second hydrocarbon flow; and
a subsystem to monitor conditioning of the de-sulfurization tank in which the first hydrocarbon flow is communicated into the tank and the second hydrocarbon flow is communicated from the tank, the subsystem adapted to monitor a characteristic of the second hydrocarbon flow to determine when the conditioning of the tank is complete.

16. The system of claim 15, wherein the characteristic comprises a pressure of the second hydrocarbon flow.

17. The system of claim 15, wherein the characteristic comprises a flow rate of the second hydrocarbon flow.

18. The system of claim 17, wherein the agent comprises a zeolite-based agent.

19. The system of claim 15, wherein the subsystem comprises at least one of the following to monitor the characteristic:
a pressure switch, a pressure sensor and a flow meter.

20. The system of claim 15, further comprising:
a second subsystem adapted to use the second hydrocarbon flow, the second subsystem adapted to be enabled to use the second hydrocarbon flow in response to the first subsystem determining that the conditioning is complete.

21. The system of claim 20, wherein the second subsystem comprises a fuel cell stack.

22. The system of claim 15, wherein the subsystem comprises a blower adapted to be operated during the conditioning of the tank to at least partially establish the second hydrocarbon flow.

23. A fuel cell system comprising:
a de-sulfurization tank comprising an agent to remove sulfur, the tank comprising an inlet to receive a first hydrocarbon flow and an outlet to provide a second hydrocarbon flow, and the tank capable of undergoing conditioning;
a reformer adapted to convert the second hydrocarbon flow into a reformate flow;
a fuel cell stack to receive the reformate flow;
a pressure monitoring device to monitor a pressure of the second hydrocarbon flow during conditioning of the tank; and
a circuit coupled to the pressure monitoring device to determine whether the conditioning of the tank is complete based on the pressure.

24. The fuel cell system of claim 23, wherein the agent comprises a zeolite-based agent.

25. The fuel cell system of claim 23, wherein the pressure monitoring device comprises at least one of the following:
a pressure switch, a pressure sensor and a flow meter.

26. The fuel cell system of claim 23, wherein the circuit is adapted to enable power production from the fuel cell stack in response to the determination that the conditioning of the tank is complete.

27. The fuel cell system of claim 23, wherein the subsystem comprises a blower adapted to be operated during the conditioning of the tank to at least partially establish the second hydrocarbon flow.

28. The fuel cell system of claim 23, wherein the blower is located downstream of the pressure monitoring device.
